(19) United States
(12) Patent Application Publication
(10) Pub. No.: US 2015/0187101 A1
(43) Pub. Date: Jul. 2, 2015

(54) DEVICE AND METHOD WITH ORIENTATION INDICATION

(71) Applicants: Hilit MAAYAN, Kfar-Yedidya (IL); Daniel Shimon COHEN, Ra'anana (IL); Jacob GREENSHPAN, Tzur-Moshe (IL)

(72) Inventors: Hilit MAAYAN, Kfar-Yedidya (IL); Daniel Shimon COHEN, Ra'anana (IL); Jacob GREENSHPAN, Tzur-Moshe (IL)

(73) Assignee: TRAX TECHNOLOGY SOLUTIONS PTE LTD., Singapore (SG)

(21) Appl. No.: 14/143,221

(22) Filed: Dec. 30, 2013

(51) Int. Cl. G06T 11/20; G06T 7/40; G06F 3/01; G06T 3/60

(52) U.S. Cl. CPC G06T 11/20; G06T 3/60; G06T 7/408; G06F 3/017

(57) ABSTRACT

An electronic device and a corresponding method are presented. The device comprises: an imager unit having a certain field of view and configured to collect image data, an orientation detection unit configured to provide orientation data of the imager unit with respect to a predetermined plane, a processing unit, and a display unit. The processing unit is configured and operable for: receiving orientation data collected by the orientation detection unit; accessing pre-stored reference orientation data and analyzing said received orientation data with respect to said reference orientation data to determine orientation variation data of the imaging unit; and transmitting data indicative of said orientation variation data to the display unit to thereby initiate displaying of a predetermined geometrical shape indicative of said orientation variation.

### TECHNOLOGICAL FIELD AND BACKGROUND

The invention is in the field of user interface applications and is particularly useful for fronto-parallel imaging of a region of scene while scanning the scene with a camera.

It is generally known that in order to obtain a meaningful image of the scene based on multiple image data pieces obtain from different points of view (e.g. scanning a scene), a stream of images sequentially acquired is analyzed in order to select those that correspond to a desired orientation of the imager with respect to the region of interest. To this end, various image processing algorithms, based typically on pattern recognition techniques, are used.

### GENERAL DESCRIPTION

The present invention provides a novel technique for user assistance in acquiring image data suitable for use in fronto-parallel panoramic images. Conventional panoramic images are generally acquired by pivoting an imaging device at a given location. In contrast, fronto-parallel panoramic images are generally acquired by scanning the imaging device along a given axis. Fronto-parallel panoramic images thereby differ from conventional panoramic images by covering a field of view of relatively low angular distribution relative to the large angular coverage of the conventional panoramic images. More specifically, while acquiring a fronto-parallel panoramic photograph, the camera/imager unit changes its point of view and generally translates along a straight line being substantially parallel to the object plane (i.e. region/scene to be imaged) while facing at a direction being substantially perpendicular to the axis of translation. This may be used, for example, for imaging of a scene, which is relatively large with respect to a camera field of view (defined by the camera optics and a distance of the camera unit from the scene). It should be noted that due to the camera's movement, variations in orientation of the camera may cause an increase in the computation resources required for image data stitching and result in lower quality of the final stitched image.

To this end, the technique of the present invention provides for assisting a user in acquiring a set of images suitable for stitching to a single, complete fronto-parallel (FP) image of a scene being larger than a field of view of the camera/imager unit used. To this end, the technique utilizes data about orientation of an electronic device, or more specifically of a camera unit used for acquiring image data, to generate a display representation in the form of a geometrical shape provided to the user on a display unit (screen) of the electronic device.

More specifically, the technique of the invention utilizes reference orientation data (e.g., based on acquisition of a first frame in a sequence or based to predetermine requirements calculated from the image data) and a current orientation data, to determine data about orientation variation. A geometrical representation indicative of the orientation variation is determined and being displayed on a suitable display unit to provide suitable indication to a user.

The geometrical representation may be a polygonal structure (e.g. quadrilateral, rectangle, hexagon etc.) and may generally be displayed as a superimposed layer of the display data, together with a representation of an image to be collected. The geometrical representation provides indication of the orientation variation by varying orientation of the edges and varying angle along the vertices of the geometrical shape to illustrate perspectives thereof, corresponding to the orientation variation. It should be noted that the orientation of the devices (e.g. of the camera unit) may be defined by three angular relations (e.g. Roll, Pitch and Yaw rotations), as well as by its location along one or more linear axes.

In some embodiments, the geometrical representation may be obtained by determining a transformation of a given geometrical shape. The given geometrical shape may be a symmetrical shape, for example a rectangle or a square. The transformation may include determining an appropriate rotation operator in accordance with the orientation variation data. The operator may be, for example, in the form of a rotation matrix varied in accordance with the orientation variation thereby providing a linear transformation operator. However, it should be noted that the transformation may be a linear transformation, a rotation, a shearing, a scaling, affine, perspective, or any combination thereof. Thus, the geometrical representation may be determined by applying a transformation operator (e.g., rotation matrix) to the given geometrical shape and determining a projection of the resulting shape on a two-dimensional plane.

Additionally, the technique may include providing an appropriate indication to the user upon determining that the orientation variation is below a predetermined threshold. More specifically, this technique may indicate to a user that the current orientation data is similar to the reference orientation data up to certain error. This may be due to existence of unavoidable error and/or due the tremor or other movement of the user's hands or the device. Additionally, an indication gradient may be used, providing a first indication when the orientation variation is below a first threshold, a second indication if the orientation variation is below a second threshold etc. This is to provide the user with additional information about a distance from the desired orientation of the imager unit.

When such indication is provided, the device may operate automatically to acquire additional image data and/or wait for the user to manually initiate the acquisition of image data. It should be noted that in addition to orientation of the camera unit, additional data about location and movement of the imager unit may be used and corresponding indication may be provided to the user. For example, the translation speed of the camera unit, and in particular, the location along one or more axes may affect the quality of the acquired image data and its suitability for use in the resulting (processed) FP image. Thus, the technique of the present invention may provide additional graphical indication about location and speed of the camera unit to thereby instruct the user about optimal location and orientation of the imager unit to acquire suitable image data pieces.

Thus, according to one broad aspect of the present invention, there is provided an electronic device comprising: an imager unit having a certain field of view and configured to collect image data, an orientation detection unit configured to provide orientation data of the imager unit with respect to a predetermined plane, a processing unit, and a display unit. Wherein the processing unit is configured and operable for: receiving orientation data collected by the orientation detection unit; accessing pre-stored reference orientation data and analyzing said received orientation data with respect to said reference orientation data to determine orientation variation data of the imaging unit; and transmitting data indicative of said orientation variation data to the display unit to thereby initiate displaying of a predetermined geometrical shape indicative of said orientation variation. The device may be configured for use in acquiring fronto-parallel image data indicative of a region being larger than a field of view of the imager unit.

According to some embodiment, the geometrical shape may be a Quadrilateral shape and the variation in orientation is indicated by transformation of the Quadrilateral shape from a rectangular form (i.e. with four right angles) to appropriate trapezoids and/or rhomboids in accordance with direction of the orientation variation.

According to some embodiments, the processing unit may be connectable to the imager unit and configured to transmit command data to the imager unit to thereby cause the imager unit to automatically acquire image data of a current field of view upon identifying that the orientation variation between current orientation and the reference orientation is below a predetermined threshold. Additionally or alternatively, the processing unit may be configured and operable to transmit data indicative of display variations corresponding to display of said geometrical shape on the display unit, to thereby provide color indication that the orientation variation is below a predetermined threshold. Generally, the orientation data may be indicative of Roll, Pitch and Yaw of the device.

The orientation detection unit may comprise one or more acceleration detection unit configured to detect variation in orientation thereof with respect to a predetermined plane. However, it should be noted that the orientation detection unit may also comprise an image processing unit configured and operable to determine orientation data in accordance image processing of temporary display data received from the imager unit.

The processing unit may be configured and operable to be responsive to a first command from a user to reset stored reference orientation data and to initiate an operation session, and to a second user's command to acquire a first image frame data, the processing unit utilizes received orientation data from the orientation detection unit as reference orientation data. Moreover, the processing unit may be configured to cause the display unit to display predetermined indication in combination with said geometrical shape if said determined orientation variation is below a predetermined threshold, to thereby provide appropriate indication to the user to acquire additional image data.

According to one other broad aspect of the invention, there is provided a method for use in image data presentation. The method comprising: providing reference orientation data; and in response to current orientation data received from one or more orientation detection units, determining orientation variation data being indicative of difference between said current orientation data and said reference orientation data about at least one axis of rotation; generating presentation data comprising data about a predetermined geometrical shape indicating said orientation variation. The presentation data may be transmitted to a display unit for presentation to a user.

Additionally, the method may comprise generating a command to a corresponding imager unit, commanding the imager unit to acquire image data indicative of a current field of view thereof in response to detection that the orientation variation is below a predetermined threshold.

As noted above, the geometrical shape may be a Quadrilateral shape. Variation in orientation may be indicated in variation of the Quadrilateral shape between rectangular form to various trapezoids and rhomboids in accordance with the orientation variation.

According to yet another broad aspect, the present invention provides a method for use in acquisition of fronto-parallel image data. The method comprising: acquiring a first image by an imager unit, determining a corresponding reference orientation data, for each subsequent image determining an orientation variation data and generating a corresponding geometrical shape for display on a display unit, the geometrical shape providing a measure of said orientation variation, the method thereby enabling acquisition of fronto-parallel images corresponding to a region larger than field of view of the imager unit.

The method may also comprise, generating, in response to determining that the orientation variation is below a predetermined threshold, corresponding indication data corresponding to a visual indication to be display on the display unit. The predetermined threshold may comprise a first threshold and a second threshold, said corresponding visual indication being indicative of a relation between said orientation variation data to at least one of the first and second threshold.

According to yet another broad aspect, the present invention provides a computer program product, implemented on a non-transitory computer usable medium having computer readable program code embodied therein to cause the computer to perform the steps of: providing a reference orientation data, in response to received orientation data, determining an orientation variation data and data about a geometrical structure indicating said orientation variation data, and processing said data about a geometrical structure to be displayed on a corresponding display unit.

According to yet another broad aspect, the present invention provides a program storage device readable by machine, tangibly embodying a program of instructions executable by the machine to perform a method for use in acquisition of fronto-parallel image data, the method comprising: acquiring a first image by an imager unit, determining a corresponding reference orientation data, for each subsequent image determining an orientation variation data and generating a corresponding geometrical shape for display on a display unit, the geometrical shape providing a measure of said orientation variation, the method thereby enabling acquisition of fronto-parallel images corresponding to a region larger than field of view of the imager unit.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A schematically illustrates a device configured according to embodiments of the present invention;

FIG. 1B exemplifies angular orientation Roll, Pitch and Yaw;

FIG. 2A and 2B illustrates some concepts of fronto-parallel imaging;

FIG. 3 shows an operational flow diagram of a technique according to certain embodiments of the present invention;

FIGS. 4A to 4J illustrate user indication about orientation data according to some embodiments of the present invention; and

FIG. 5 illustrates additional example of user indication about orientation data according to some embodiments of the present invention.

### DETAILED DESCRIPTION OF EMBODIMENTS

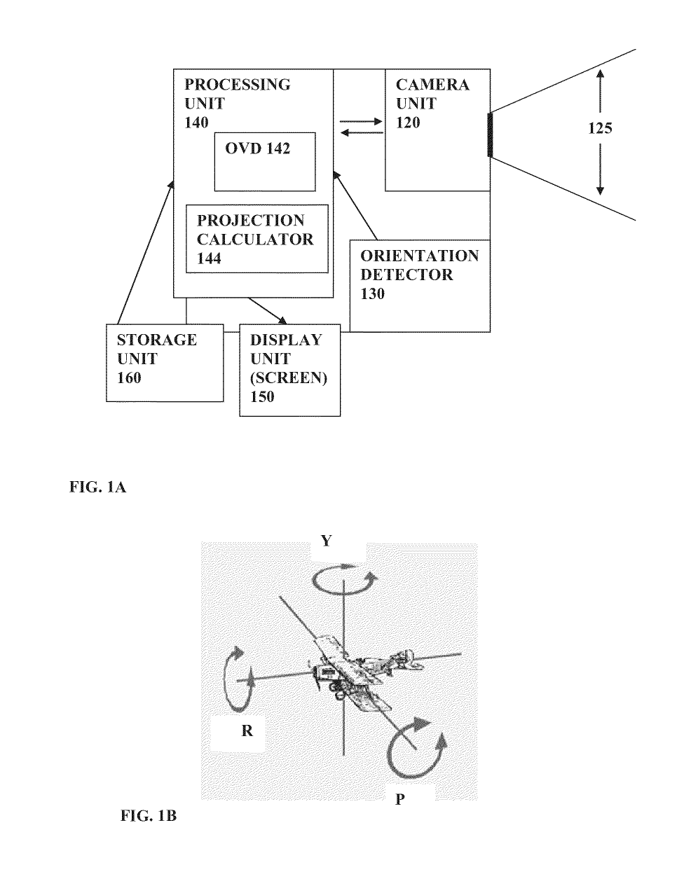

Reference is made to FIG. 1A schematically illustrating an electronic device 100 configured according to the present invention. The device may be of any type of electronic device including but not limited to a hand held device (e.g. mobile phone, smartphone, digital camera, laptop) or camera unit being connectable to a stationary computing device (e.g. desktop computer). The device 100 includes a camera/imager unit 120, an orientation detection unit 130 and a processing unit 140, the latter is connectable to the camera/imager unit 120 and the orientation detection unit 130 for data transmission to and from thereof. The device 100 is also connectable with at least a display unit 150 and a storage unit 160, which may be integral with the device 100 or remote therefrom connectable through wired or wireless communication network.

The electronic device 100 of the present invention is configured to collect image data suitable for use to provide a wide field of view fronto-parallel (FP) image which is corresponding to a region being larger than a field of view 125 of the camera unit 120. To this end, FP image may be produced from a set of two or more pieces of image data (frames) stitched together along one or two axes to form a single image corresponding to the regions of all the frames combined. To provide high quality FP images, the electronic device 100 is configured to provide user assistance for alignment of the camera unit while acquiring the different frames. According to the present invention, the electronic device is configured to provide graphical indication about orientation of the camera unit 120 in the form of a geometrical structure displayed on a display unit 150 associated with the device. It should be noted that the display unit 150 may be integral with the device 100 or connectable thereto by wired or wireless communication.

To this end, the camera unit 120 is connectable to the processing unit 140 for transmission of image data being either preview image data and/or image data associated with an acquired frame collected by the camera unit 120. Additionally, the device 100 includes an orientation detection unit 130 (ODU) configured to determine orientation of the device 100 (generally of the camera unit 120) about at least one axis. The ODU 130 is connectable to the processing unit 140 and configured to transmit current orientation data for processing. It should be noted that the orientation detection unit 130 may be based on one or more physical sensors, e.g. acceleration sensors, configured to detect orientation of the device 100 with respect to the ground and/or integrate rotation thereof to determine current orientation data. alternatively or additionally, the orientation detection unit may be formed as a sub-processing unit being a part of the processing unit 140 or not. In this configuration the orientation detection unit 130 may be configured and operable to apply image processing analysis algorithms on temporary image data provided by the camera unit 120 (similar to image data used to provide preview of the scene being imaged) to thereby determine orientation data based on the image data. For example, determining orientation based on angular relation between lines in the image data.

For example, the orientation data may be determined as angular orientation of the device 100 (e.g. of the camera unit 120 thereof) about one or more axes. Generally orientation of the device is determined by providing angular orientation thereof about three perpendicular axes, thereby resulting in three parameters such as Roll, Pitch and Yaw as known in the art and exemplified in FIG. 1B.

The processing unit 140 is configured and operable to be responsive to orientation data received from the ODU 130 and to compare the received/current orientation data (COD) with stored reference orientation data (ROD) (e.g., being stored at the storage unit of the device). The processing unit comprises an orientation variation detector 142 (OVD) configured to compare the COD and ROD and to determine data about orientation variation (e.g. a difference between the reference orientation data and the current orientation data), and a projection calculator module 144 configured to determine a suitable graphic representation of the orientation variation. The processing unit may prepare the determined suitable graphic representation of the orientation variation and transmits it to be displayed to the user.

It should be noted that generally, the orientation detection unit 130 may provide periodic transmission of orientation data, e.g., at a rate of 100 measurements per second. Thus, certain averaging of the received orientation data and/or of the orientation variation data may be used to thereby provide a smooth display to the user. Constant movement of the device may generate fast variations in orientation which may render the “on-screen” notification unreadable. Thus, the processing unit may be configured to average the current orientation data and/or the orientation variation data along certain period to remove such fast variations. The processing unit may calculate the orientation variation based on the average orientation data acquired during a period of between 1/1000 to 1 second. It should be noted that the averaging period or smoothing level of the display data may be adjustable in accordance with user's preferences and/or environment conditions.

As indicated above, the electronic device 100 of the present invention may be configured for use in acquisition of fronto-parallel (FP) images of a region larger than a field of view 125 of the camera unit 120. For example, the device may be used for providing image data corresponding to long horizontal elements (e.g. supermarket shelves) located such that a maximal distance away from the element is limited and thus also the field of view 125. In this example, a complete FP image may be acquired by combining/stitching a set of frames acquired at different locations along the element. However, in order to provide high quality FP image, the different frames are preferably collected at similar distances and similar orientation to one another as possible.

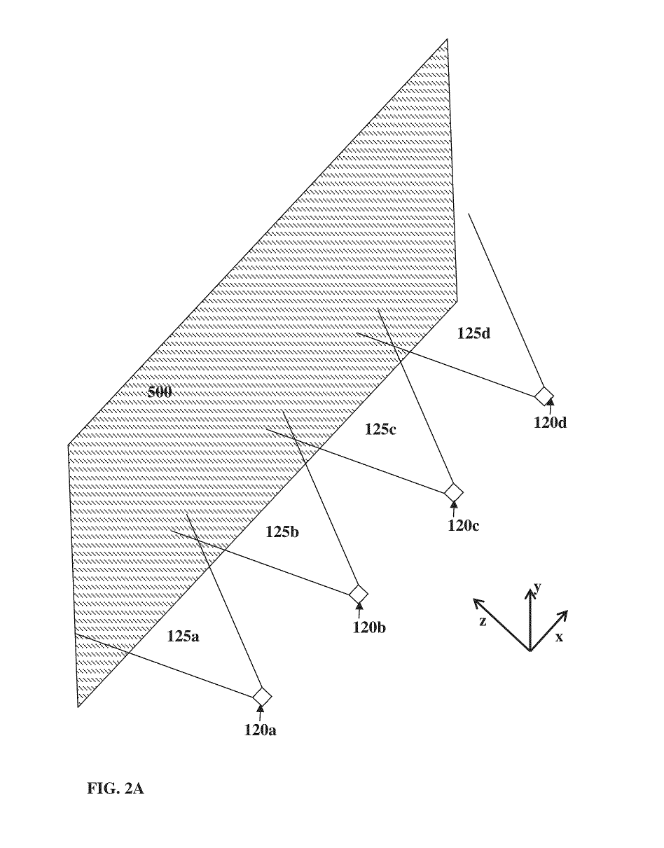

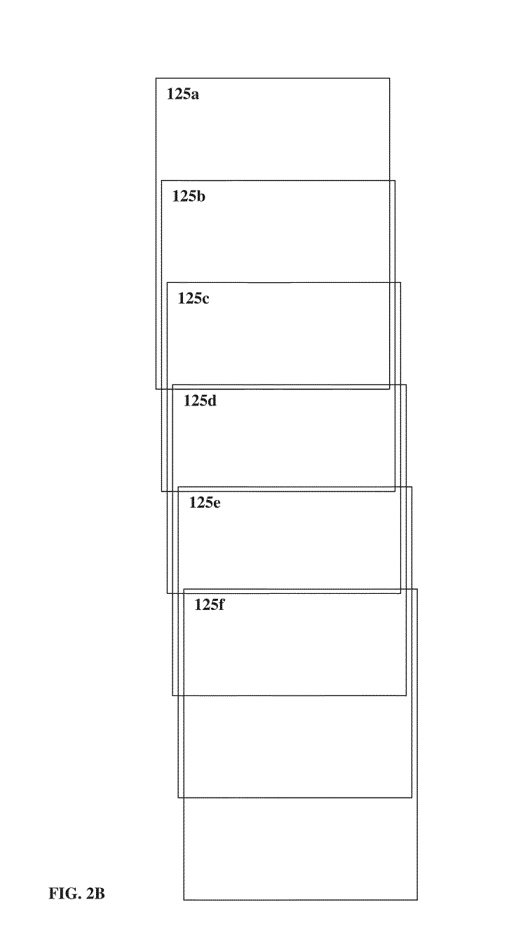

The idea and concept of FP imaging is illustrated in FIGS. 2A and 2B. FIG. 2A exemplifies the use of FP imaging for providing image data of a region 500 being larger than field of view 125 of the camera unit 120 (taking into consideration the location of the camera unit). In this example, the camera unit 120 is shown as acquiring four different pieces of image data corresponding to field of view 125a-125d, where the camera itself translated along an axis x being parallel to the region 500 to be imaged to four different positions 120a-120d. FIG. 2B exemplifies the stitching of several frames (6 frames in this not limiting example) acquired from different locations of the camera unit. As shown, each of the six frames has a field of view 125a-125f associated with the field of view of the camera unit at different locations. It should be noted that the rectangles illustrating field of view of the camera unit at different locations, i.e. rectangles 125a-125f are translated with respect to one another along the short axis thereof only to illustrate the differences and to allow the reader to distinguish between them. According to the present invention, translation between frames is preferred to be along a single axis. It should also be noted that several elongated FP images may be joined together by stitching along the shirt axes thereof, to thereby form a 2-dimensional FP image.

It should also be noted that various frame stitching algorithms may be used to provide the complete FP image of the desired scene. The appropriate algorithms vary with respect to a type of the scene to be recorded and/or various other computational requirements that may arise.

Reference is made to FIG. 3 illustrating a flow diagram of an operational example according to the present invention. As shown, a user starts a FP imaging sequence and acquires a first frame 1000, e.g. located at a far right edge of the region of interest. The processing unit (140), retrieves orientation data 1100 corresponding to orientation of the camera unit (120) at the time the user acquires the first frame, and stores 1200 this data as reference orientation data (ROD), e.g. at the storage unit (160). When the user moves the device (100), the operational loop 2000 continues, and the processing unit retrieves orientation data periodically. More specifically, the processing unit (140) retrieves a sequence of current orientation data pieces (COD) from the ODU (130), each COD data piece corresponds to the orientation of the camera unit at a certain time. The OVD (142), receives the COD and determines orientation variation 1300 data with respect to the stored ROD. The projection calculator (144) received the data about orientation variation, and determines an appropriate graphical structure corresponding to the orientation variation 1400. This graphical representation is preferably presented on a display unit (150) to provide indication on orientation data to the user. When the calculated orientation variation data is determined to be below a predetermined threshold (i.e. current orientation is similar to reference orientation up to certain predetermined allowed limit) the processing unit provides a suitable notification to the user to direct him to acquire an additional image 1010. According to certain embodiments, the user may indicate a sufficient translation of the camera unit and the processing unit may operate the camera unit to acquire an additional image automatically 1600.

As indicated above, the technique of the invention may also utilize translation data along or more axes. To this end, such translation data may be provided by the orientation detection unit 130 or a corresponding accelerometer configured to provide linear translation data. It should be noted that such translation data may be use to provide proper indication to the user regarding location, thereof with respect to location of a previous frame acquisition step, and or speed of movement. Thus, if the user moves the camera too fast (or too slow), the processing unit may provide a suitable notification indicating the user of an optimal movement speed to provide desired image data.

According to some embodiments of the invention, the processing unit 140 (or e.g., the projection calculator 144) may use transformation of a geometrical shape to determine the appropriate indication to be displayed. For example, the projection calculator 144 may receive orientation variation data from the OVD 142 in the form of three angles being indicative of the variation in Roll θ, Pitch φ and Yaw ω. The projection calculator 144 may determine an appropriate three-dimensional rotation operator R which may be in the form:

$$R = [ \begin{matrix}1 & 0 & 0 \\ 0 & cos ( α θ ) & - sin ( α θ ) \\ 0 & sin ( αθ ) & cos ( αθ )\end{matrix} ] \times [ \begin{matrix}cos ( β φ ) & - sin ( β φ ) & 0 \\ sin ( βφ ) & cos ( βφ ) & 0 \\ 0 & 0 & 1\end{matrix} ] \times [ \begin{matrix}cos ( γ ω ) & 0 & sin ( γ ω ) \\ 0 & 1 & 0 \\ - sin ( γ ω ) & 0 & cos ( γ ω )\end{matrix} ]$$

where α, β and γ are scaling parameters selected to allow proper variation of the displayed indication, i.e. to provide enhanced accuracy and/or wide overview of the device's orientation. It should be noted that these scaling parameters may be determined in accordance with the value of the orientation variation, in total or for each axis separately.

The projection calculator 144 utilizes the rotation operator R to determine 3D orientation of a rectangular model, which may for example be described by four vertices located at vectorial locations (0,0,1), (0,A,1), (B,A,1) and (B₄0,1), thereby resulting in rotation of the rectangle model in 3D space. The rotated model may be determined by applying the rotation operator on each of the model's vertices. It should be noted that the third coordinate value is a a predetermined values which may vary in accordance with the computational technique. This depth coordinate will be eliminated by determining the projection of the geometrical shape onto a 2D surface and by replacing the shape to be displayed on the display unit.

It should be noted that the original orientation of the model may generally be determined in accordance with actual orientation of the display unit to provide more intuitive displayed data. It should also be noted that the size and width of the model may typically be determined in accordance with an aspect ratio of the display unit.

The rotated model is projected onto a two-dimensional space to provide simple and understandable representation thereof on the display unit. To this end, the projection calculator 144 may operate to determine a ratio between each coordinate value of the rotated model by the value of the depth coordinate (the coordinate which is set to zero in the initial model before rotation). Alternatively, the depth coordinate of the rotated model may be set to zero to provide an appropriate two-dimensional projection. This provides a set of four vertices and their location in a 2D space. The respective value of the vertices' location may be scaled to adjust representation of the model to an aspect ratio of the display unit and centered with respect to the display unit. The projection calculator 144 thus determined representation data suitable to provide indication of orientation variation of the device and for display to a user.

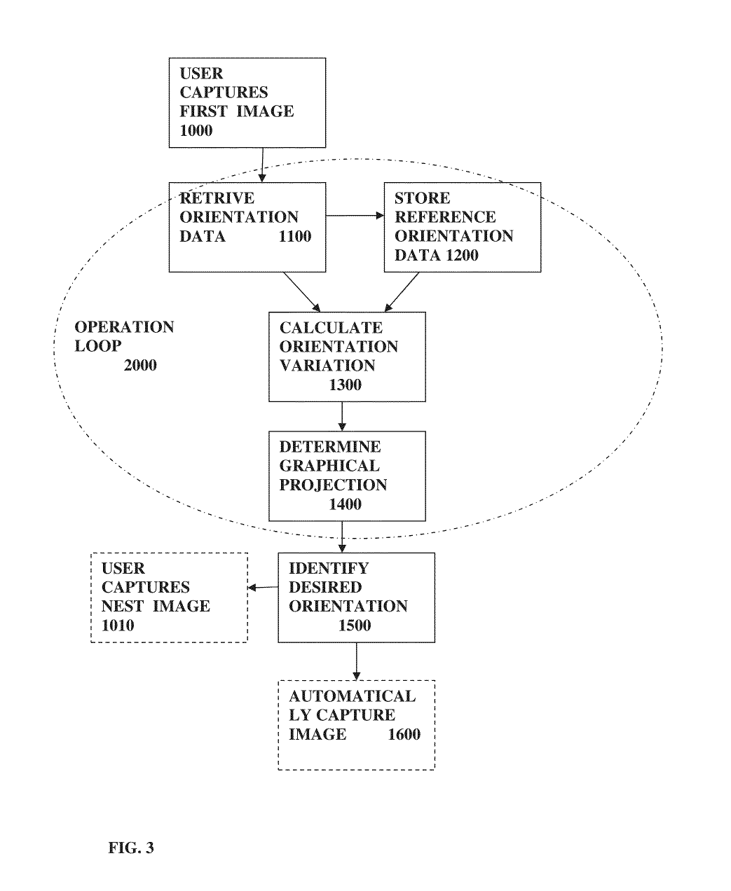

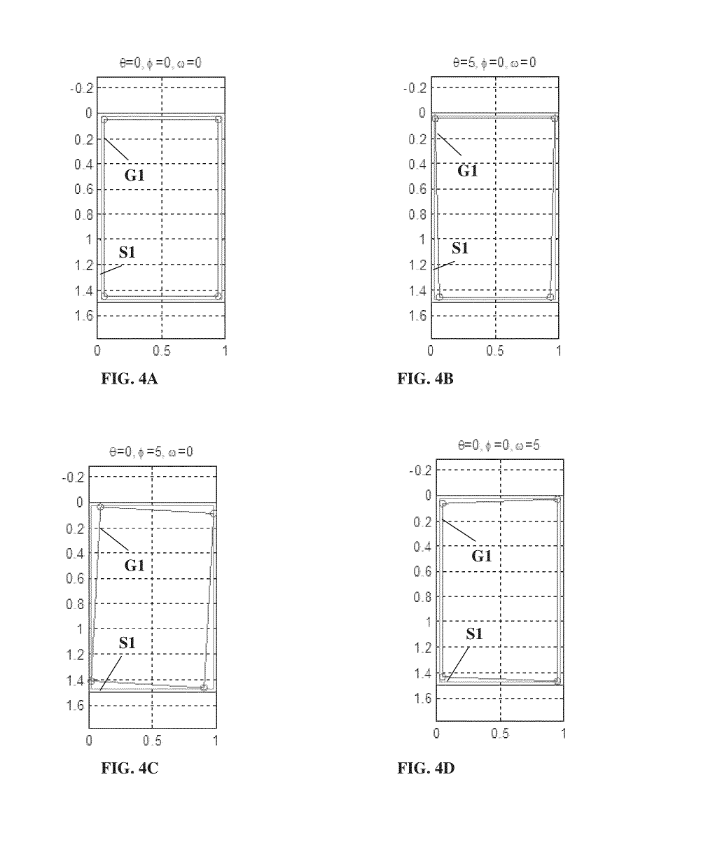

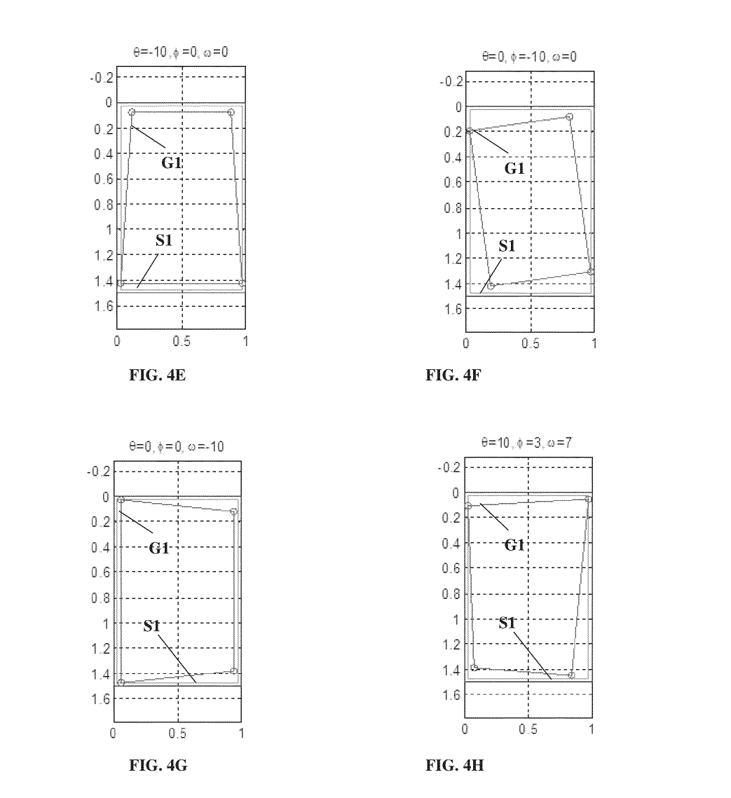

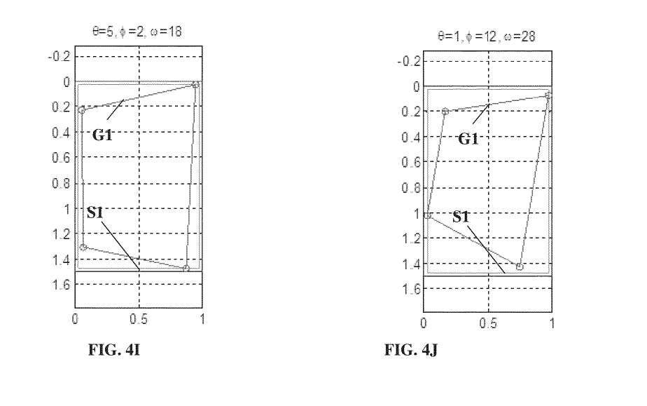

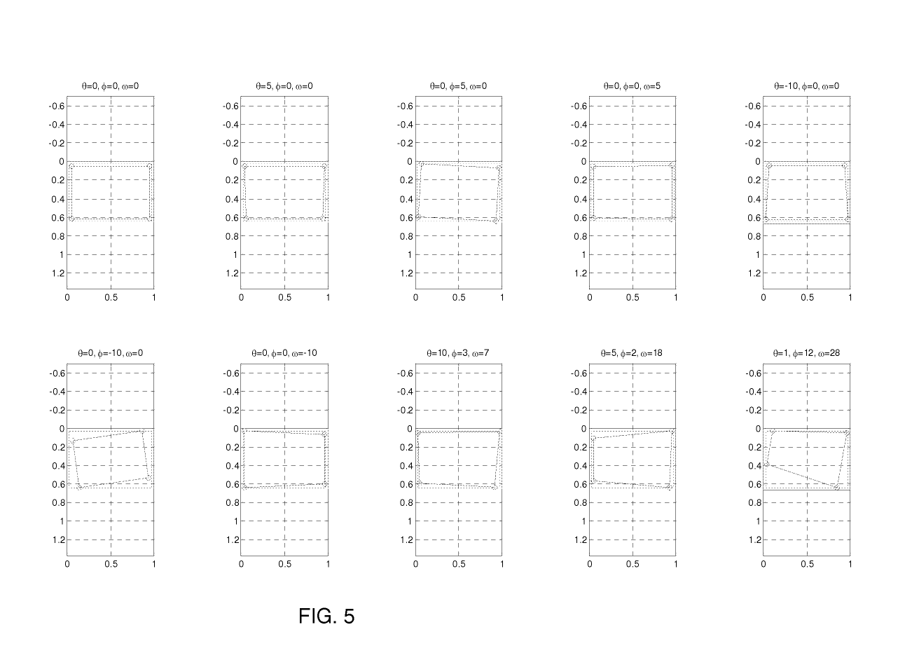

As indicated above, the graphical indication may be in the form of a geometrical shape illustrating orientation variation of the device. Examples of such indication to the user are illustrated in FIGS. 4A to 4J showing variations in graphical representation in accordance with orientation variation data. According to this example of the invention, the geometrical structure is presented to the user as if observed from orientation which corresponds to the determined orientation variation. As exemplified in FIGS. 4A to 4J the geometrical structure may be in the form of a rectangle G1 shown on the display unit as a layer on top of any other required display data S1 (e.g. a layer on top of a preview of the field of view). FIG. 4A shows zero orientation variation, in such orientation, both the Roll (φ), Pitch (θ) and Yaw (ω) are zero with respect to the reference orientation data. Various variations in orientation are exemplified, including Roll variation (FIGS. 4C and 4F showing variation of φ between 5° and −10°), Pitch variation (FIGS. 4B and 4E showing variation of θ between 5° and −10°), Yaw variation (FIGS. 4D and 4G showing variation of ω between 5° and −10°) and combined variations illustrated in FIGS. 4H to 4J. It should be noted that the represented shape is generally illustrated in a way that indicate the actual variation to the user. Thus, the geometrical structure is generally shown from a point of view corresponding to the actual orientation variation data. Suitable graphical indications, corresponding to landscape orientation of the display (other than portrait orientation) are similarly exemplified in FIG. 5.

It should be noted that the effects of the camera orientation on the geometrical structure can be modified according to the scene and according to user preferences and/or camera operation history. These conditions may affect the determined value of parameters such as averaging period, appropriate first and second threshold values and linearity parameters such as α, β and γ described above. This is to provide appropriate graphical representation and to allow modifications thereof in accordance with a desired application.

It should be noted that the geometrical structure may be illustrated within the display region of the display unit. This may require appropriate re-scaling of the illustrated shape to reduce size thereof upon orientation variations. Alternatively, the structure may be illustrated such that at high variation in orientation, certain parts of the structure are outside the boundaries of the display region.

Thus, the present invention provides a novel technique and electronic device, configured to provide graphical indication of orientation variation thereof. The device is generally designed for use in acquiring of fronto-parallel imaging of a region larger than a field of view of the camera. However, it should be noted that the technique of the present invention may be used for various other techniques and process requiring appropriately aligned image acquisition.

1. An electronic device comprising: an imager unit having a certain field of view and configured to collect image data, an orientation detection unit configured to provide orientation data of the imager unit with respect to a predetermined plane, a processing unit, and a display unit;
wherein the processing unit is configured and operable for:
receiving orientation data collected by the orientation detection unit;
accessing pre-stored reference orientation data and analyzing said received orientation data with respect to said reference orientation data to determine orientation variation data of the imaging unit; and
transmitting data indicative of said orientation variation data to the display unit to thereby initiate displaying of a predetermined geometrical shape indicative of said orientation variation.

2. The electronic device of claim 1, wherein said geometrical shape is a Quadrilateral shape and the variation in orientation is indicated by transformation of the Quadrilateral shape from a rectangular form to appropriate trapezoids and rhomboids in accordance with direction of the orientation variation.

3. The device of claim 1, wherein the device is configured for use in acquiring fronto-parallel image data indicative of a region being larger than a field of view of the imager unit.

4. The device of claim 1, wherein the processing unit is connectable to the imager unit and configured to transmit command data to the imager unit to thereby cause the imager unit to automatically acquire image data of a current field of view upon identifying that the orientation variation between current orientation and the reference orientation is below a predetermined threshold.

5. The device of claim 1, wherein the processing unit is configured and operable to transmit data indicative of display variations corresponding to display of said geometrical shape on the display unit, to thereby provide color indication that the orientation variation is below a predetermined threshold.

6. The device of claim 1, wherein said orientation data is indicative of Roll, Pitch and Yaw of the device.

7. The device of claim 1, wherein the orientation detection unit comprises one or more acceleration detection unit configured to detect variation in orientation thereof with respect to a predetermined plane.

8. The device of claim 1, wherein the orientation detection unit comprises an image processing unit configured and operable to determine orientation data using processing of temporary display data received from the imager unit.

9. The device of claim 1, wherein the processing unit is configured and operable to be responsive to a first command from a user to reset stored reference orientation data and to initiate an operation session, and to a second user's command to acquire a first image frame data, the processing unit utilizing received orientation data from the orientation detection unit as reference orientation data.

10. The device of claim 9, wherein the processing unit is configured to cause the display unit to display predetermined indication in combination with said geometrical shape if said determined orientation variation is below a predetermined threshold, to thereby provide appropriate indication to the user to acquire additional image data.

11. A method for use in image data presentation, the method comprising: providing reference orientation data; and in response to current orientation data received from one or more orientation detection units, determining orientation variation data being indicative of difference between said current orientation data and said reference orientation data about at least one axis of rotation; generating presentation data comprising data about a predetermined geometrical shape indicating said orientation variation.

12. The method of claim 11, comprising transmitting said presentation data to a display unit for presentation to a user.

13. The method of claim 11, comprising generating a command to a corresponding imager unit, commanding the imager unit to acquire image data indicative of a current field of view thereof in response to detection that the orientation variation is below a predetermined threshold.

14. The method of claim 11, wherein said geometrical shape being a Quadrilateral shape, variation in orientation is indicated in variation of the Quadrilateral shape between rectangular form to various trapezoids and rhomboids in accordance with the orientation variation.

15. A method for use in acquisition of fronto-parallel image data, the method comprising: acquiring a first image by an imager unit, determining a corresponding reference orientation data, for each subsequent image determining an orientation variation data and generating a corresponding geometrical shape for display on a display unit, the geometrical shape providing a measure of said orientation variation, the method thereby enabling acquisition of fronto-parallel images corresponding to a region larger than field of view of the imager unit.

16. The method of claim 15, comprising generating, in response to determining that the orientation variation is below a predetermined threshold, corresponding indication data corresponding to a visual indication to be display on the display unit.

17. The method of claim 16, wherein said predetermined threshold comprises a first threshold and a second threshold, said corresponding visual indication being indicative of a relation between said orientation variation data to at least one of the first and second threshold.

18. A computer program product implemented on a non-transitory computer usable medium having computer readable program code embodied therein to cause the computer to perform the steps of: providing a reference orientation data, in response to received orientation data, determining an orientation variation data and data about a geometrical structure indicating said orientation variation data, and processing said data about a geometrical structure to be displayed on a corresponding display unit.

19. A program storage device readable by machine, tangibly embodying a program of instructions executable by the machine to perform a method for use in acquisition of fronto-parallel image data, the method comprising: acquiring a first image by an imager unit, determining a corresponding reference orientation data, for each subsequent image determining an orientation variation data and generating a corresponding geometrical shape for display on a display unit, the geometrical shape providing a measure of said orientation variation, the method thereby enabling acquisition of fronto-parallel images corresponding to a region larger than field of view of the imager unit.
